(19) United States
(12) Patent Application Publication
(10) Pub. No.: US 2026/0119420 A1
(43) Pub. Date: Apr. 30, 2026

(54) SEMICONDUCTOR INTEGRATED CIRCUIT DEVICE AND CONTROLLER DEVICE

(71) Applicant: DENSO CORPORATION, Kariya-city (JP)

(72) Inventors: Shinichiro NAKATA, Kariya-city (JP); Tomohisa KISHIGAMI, Kariya-city (JP); Akira SUZUKI, Kariya-city (JP)

(21) Appl. No.: 19/421,571

(22) Filed: Dec. 16, 2025

Related U.S. Application Data
(63) Continuation of application No. PCT/JP2024/022613, filed on Jun. 21, 2024.

(30) Foreign Application Priority Data
Jul. 7, 2023 (JP) 2023-112280

(51) Int. Cl. G06F 13/16; G06F 13/24; G06F 13/42

(52) U.S. Cl. CPC G06F 13/1689; G06F 13/24; G06F 13/4282

(57) ABSTRACT

The control circuit receives a signal from the communication bus even when the arithmetic device of the controller device is in a normal state. The control circuit acquires the data corresponding to the specific communication data from the received data. The control circuit verifies the data with the data stored in the memory circuit using the verification circuit. If the data is verified, the control circuit transmits the continuation determination signal for maintaining the arithmetic device of the controller device in a normal state to the arithmetic device of the controller device, and stops transitioning the arithmetic device of the controller device to a sleep state.

### CROSS REFERENCE TO RELATED APPLICATION

The present application is a continuation application of International Patent Application No. PCT/JP2024/022613 filed on Jun. 21, 2024, which designated the U.S. and claims the benefit of priority from Japanese Patent Application No. 2023-112280 filed on Jul. 7, 2023. The entire disclosures of all of the above applications are incorporated herein by reference.

### TECHNICAL FIELD

The present disclosure relates to a semiconductor integrated circuit device and a controller device.

### BACKGROUND ART

Conventionally, a communication circuit is proposed such that the communication circuit constitutes selective type partial network management. According to this communication technique, in a network system in which a plurality of ECUs are arranged on the same communication bus, for example, it is possible to cause a specific group of ECUs to transition to a sleep state when the operation of the specific group of ECUs is no longer required.

Furthermore, a conceivable technique teaches a feature in which a master ECU transmits activation conditions determined for each of the slave ECUs so that each of the slave ECUs receives the activation conditions, respectively. With this feature, the activation information is compared with the activation conditions, and if the wake-up conditions are satisfied, the state is transitioned from the sleep state to the normal state.

### SUMMARY OF INVENTION

According to an example, a semiconductor integrated circuit device receives a signal from a communication bus connecting a plurality of ECUs. The semiconductor integrated circuit device may include: a reception circuit that receives the signal from the communication bus, converts the signal into a voltage level of data that can be received by a controller device equipped with an arithmetic device, and causes the controller device to input the signal as a reception signal; a transmission circuit that receives a transmission signal from the controller device, converts the transmission signal to a predetermined voltage level, and transmits the transmission signal to the communication bus; a communication circuit that is in communication with the controller device; and a control circuit that is configured to transition the arithmetic device of the controller device from a normal state to a sleep state upon receiving a sleep signal from the controller device. The control circuit may include: a memory circuit that stores data for transitioning the arithmetic device of the controller device from the sleep state to the normal state; and a verification circuit that verifies whether specific communication data matching the data stored in the memory circuit has been received from the communication bus in accordance with a predetermined communication protocol when the arithmetic device of the controller device is in the sleep state. The control circuit receives the signal from the communication bus even when the arithmetic device of the controller device is in the normal state. The control circuit acquires data corresponding to the specific communication data from received signal. The control circuit verifies acquired data with the data stored in the memory circuit using the verification circuit. If the acquired data is verified, the control circuit transmits a continuation determination signal for maintaining the arithmetic device of the controller device in the normal state to the arithmetic device of the controller device, and stops transitioning the arithmetic device of the controller device to the sleep state.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an electrical configuration diagram schematically showing a vehicle system according to a first embodiment;

FIG. 2 is an explanatory diagram illustrating contents of data frame of the CAN according to the first embodiment;

FIG. 3 is a flowchart illustrating an operation according to the first embodiment;

FIG. 4 is a timing flowchart illustrating an operation according to the first embodiment;

FIG. 5 is an explanatory diagram showing contents of a specific communication data according to the first embodiment;

FIG. 6 is an electrical configuration diagram schematically showing a vehicle system according to a second embodiment;

FIG. 7 is an electrical configuration diagram schematically showing a vehicle system according to a third embodiment;

FIG. 8 is an electrical configuration diagram schematically showing a vehicle system according to a fourth embodiment; and

FIG. 9 is an electrical configuration diagram schematically showing a vehicle system according to a fifth embodiment.

### DETAILED DESCRIPTION

The inventors have considered a system in which a controller device and a semiconductor integrated circuit device are configured separately from each other in relation to the technique described in the Background Art. The semiconductor integrated circuit device is configured to activate the controller device when a predetermined activation condition is satisfied while the semiconductor integrated circuit device is in a sleep state.

However, for example, when the semiconductor integrated circuit device receives a communication frame from the communication bus in the normal state, if the controller device is allowed to receive the communication frame as it is, the arithmetic device of the controller device may read the communication frame and determine whether to continue the normal state which is continued from the activation of the controller device or to transition to the sleep state. In this case, the processing load of the arithmetic device of the controller device becomes large, which causes difficulties such as making it impossible to adopt an inexpensive controller device or imposing restrictions on the software functions of the arithmetic device of the controller device.

An object of the present embodiments is to provide a semiconductor integrated circuit device and a controller device that are capable of reducing the processing load on an arithmetic device configured in the controller device.

According to one aspect of the present embodiments, a semiconductor integrated circuit device receives a signal from a communication bus that is connected to a plurality of ECUs. The reception circuit receives a signal from the communication bus, converts the signal into a voltage level of data that can be received by a controller device having an arithmetic device, and causes the controller device to receive the signal as a reception signal. The transmission circuit receives a transmission signal from the controller device, converts the transmission signal to a predetermined voltage level, and transmits the transmission signal to the communication bus. The communication circuit is in communication with the controller device. The control circuit is configured to transition the controller device from the normal state to the sleep state upon receiving a sleep signal from the controller device.

The control circuit includes a memory circuit that stores data for transitioning the arithmetic device of the controller device from a sleep state to a normal state; and a verification circuit for verifying whether specific communication data matching data stored in the memory circuit has been received from the communication bus in accordance with a predetermined communication protocol when the arithmetic device of the controller device is in a sleep state.

The control circuit receives a signal from the communication bus even when the arithmetic device of the controller device is in a normal state. The control circuit acquires the data corresponding to the specific communication data from the received data. The control circuit verifies the data with the data stored in the memory circuit using the verification circuit. If the data is verified, the control circuit transmits the continuation determination signal for maintaining the arithmetic device of the controller device in a normal state to the arithmetic device of the controller device, and stops transitioning the arithmetic device of the controller device to a sleep state.

According to one aspect of the present disclosure, even when the arithmetic device of the controller device is in a normal state, the verification circuit verifies the specific communication data received from the communication bus with data stored in the memory circuit, similar to the sleep state. Thus, it is possible to reduce the burden on the arithmetic device of the controller device in the determination process for maintaining the normal state by itself, and also reduce the burden on the arithmetic process for executing the determination whether to transition to the sleep state. Thus, it is possible to reduce the process load on the arithmetic device of the controller device.

One aspect of the present disclosure is directed to a controller device that transmits and receives signals to and from a transceiver device that is connected to a communication bus that connects a plurality of ECUs. The controller device includes a communication controller, an arithmetic device, and a control circuit. The communication controller transmits and receives signals through the transceiver device. The control circuit can transition the arithmetic device to a sleep mode when a sleep signal is received from the communication controller.

The control circuit includes a memory circuit for storing data for transitioning to the normal state; and a verification circuit for verifying whether specific communication data matching data stored in the memory circuit has been received from the transceiver device in accordance with a predetermined communication protocol when the arithmetic device is in a sleep state. The control circuit receives a signal from the communication controller even when the arithmetic device is in a normal state. The control circuit acquires the data corresponding to the specific communication data from the received data. The control circuit verifies the data with the data stored in the memory circuit using the verification circuit. If the data is verified, the control circuit transmits the continuation determination signal for maintaining the arithmetic device in a normal state to the arithmetic device, and stops transitioning the arithmetic device to a sleep state. Thus, it is possible to reduce the burden on the arithmetic device of the controller device in the determination process for maintaining the normal state by itself, and also reduce the burden on the arithmetic process for executing the determination whether to transition to the sleep state. Thus, it is possible to reduce the process load on the arithmetic device of the controller device.

Hereinafter, several embodiments of the semiconductor integrated circuit device will be described. In the following embodiments, substantially same structural configurations are designated with the same reference symbols to simplify the description.

### First Embodiment

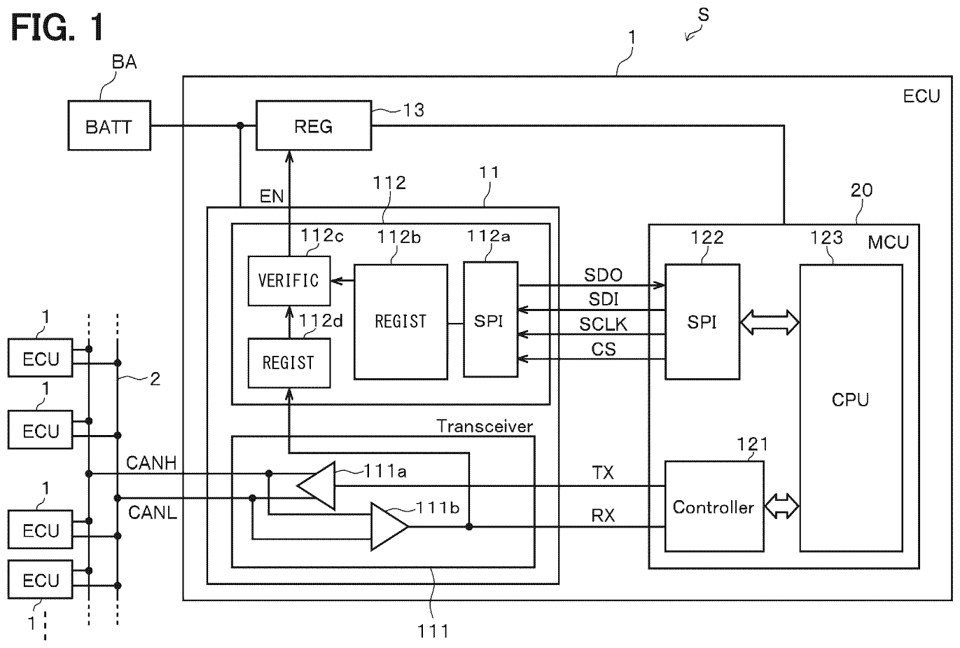

The following describes a first embodiment with reference to FIGS. 1 to 5. Vehicles are equipped with electronic control units 1 (hereinafter referred to as ECUs 1) for vehicles and the number of such units mounted on the vehicle is increasing year by year. For this reason, it is necessary to minimize the power consumption of the ECU 1 that is not required to operate. In recent years, in response to such demands, a partial network management system S (hereinafter abbreviated as system S) as shown in FIG. 1 has been configured in a vehicle. The system S is configured by connecting a plurality of clustered ECUs 1 to one communication bus 2 or to a plurality of communication buses 2 via a vehicle gateway.

Each of the plurality of ECUs 1 belongs to one or more groups among the cluster groups. In the vehicle, the same identification code is assigned to each ECU 1 for each cluster group to which the ECU 1 belongs, and the identification code indicating the cluster group is stored inside the ECU 1. Although FIG. 1 shows the internal electrical configuration block of one ECU 1, the other ECUs 1 have the same configuration. Therefore, the electrical configuration of one ECU 1 will be described below.

The ECU 1 is configured by connecting a driver IC 11 as a semiconductor integrated circuit device and an MCU 20 as a controller device. The power source from the external battery BA is supplied to the driver IC 11. The power source circuit 13 is configured so that the power source circuit 13 can be enabled/disabled by a control circuit 112 (described later) of the driver IC 11. The power source circuit 13 is enabled by default, and supplies electric power to the MCU 20 when enabled. When the power source circuit 13 is disabled by the control circuit 112, the power source circuit 13 cuts off the power supply to the MCU 20.

The MCU 20 is configured by a microcontroller unit including a communication controller 121, a communication circuit 122, and a CPU 123 as an arithmetic device. The driver IC 11 receives a signal from the communication bus 2.

The driver IC 11 includes a transceiver 111 and a control circuit 112. The driver IC 11 is connected to the communication bus 2 through a transceiver 111. The transceiver 111 includes a transmission circuit 111a and a reception circuit 111b. The reception circuit 111b receives a signal from the communication bus 2, converts the signal into a voltage level of data that can be received by the MCU 20, and causes the MCU 20 to receive the signal as a reception signal RX. The transmission circuit 111a receives a transmission signal TX from the MCU 20, converts the transmission signal to a predetermined voltage level, and transmits the transmission signal to the communication bus 2.

The MCU 20 can transition between a normal state, which is a normal operation mode, and a sleep state, which is a low power consumption mode. In a normal state, the MCU 20 is capable of communicating data with other ECUs 1 via the transceiver 111 using a predetermined communication protocol. The predetermined communication protocol used here is the CAN protocol.

Here, CAN is a registered trademark and is an abbreviation for Controller Area Network. Thus, it is possible to apply the present feature to a communication bus 2 that uses the CAN communication. In this embodiment, the communication protocol of the communication bus 2 is described as Classic-CAN, but this is not particularly limited, and other protocols such as CAN-FD, CXPI, and LIN can also be applied in the field of vehicle communications.

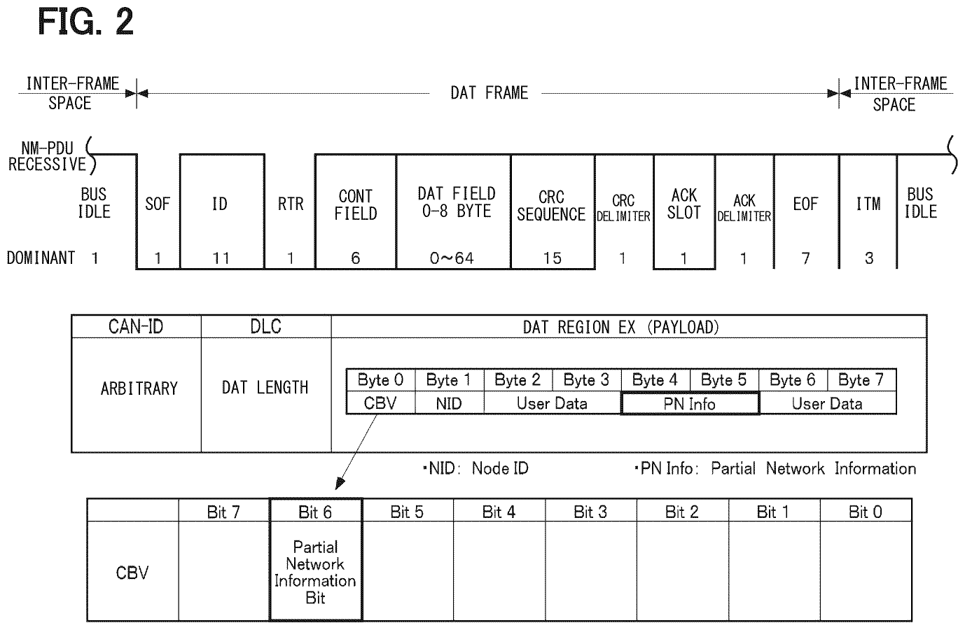

FIG. 2 shows a data frame of Classic-CAN. A data frame includes SOF (i.e., Start Of Frame), ID (i.e., Identification), RTR (i.e., Remote Transmission Request), control field, data field, CRC (i.e., Cyclic Redundancy Check) sequence, CRC delimiter, ACK slot, ACK delimiter, and EOF (i.e., End Of Frame).

The control field is configured by a 1-bit IDE (i.e., Identifier Extension), a reservation bit, and a 4-bit DLC (i.e., Data Length Code). The CBV in the data area has the sixth bit from the upper rank indicating the PN information bit, and if the sixth bit is “1”, the data indicates that the frame is a communication frame related to a partial network. For example, if the CBV is “0x40”, the data indicates that the frame is a communication frame related to a partial network.

The first byte NID in the data area indicates a node identification number (i.e., Node ID), and the fourth and fifth bytes indicate PN information (i.e., Partial Network Information) included in the NM-PDU. The PN information is used as specific communication data and bit information, and is used as information that can determine which ECU 1 belonging to the cluster group will be in the normal state or the sleep state.

The description will be continued by returning the reference drawing to FIG. 2. The control circuit 112 includes a communication circuit 112a, a register 112b, a verification circuit 112c, and a register 112d. The register 112d is used as a memory circuit for temporarily storing data of the reception signal RX. The register 112b is used as a memory circuit for storing data for transitioning the CPU 123 of the MCU 20 from the sleep state to the normal state. Although the registers 112b and 112d are shown as being used, volatile memory such as RAM or non-volatile memory such as E2PROM may be used for each of them.

The communication circuit 112a can transmit the data stored in the register 112 b to the communication circuit 122 of the MCU 20. The communication circuit 112a will be described as using serial communication using, for example, SPI (i.e., Serial Peripheral Interface), alternatively, the communication circuit 112a may also use UART (i.e., Universal Asynchronous Receiver Transmitter), I2C (i.e., Inter-Integrated Circuit), or a parallel communication line (i.e., direct line). When the control circuit 112 receives a sleep signal from the MCU 20 via the communication circuit 112a, the control circuit 112 can transition the MCU 20 from the normal state to the sleep state.

<State Transition from Normal State to Sleep State>

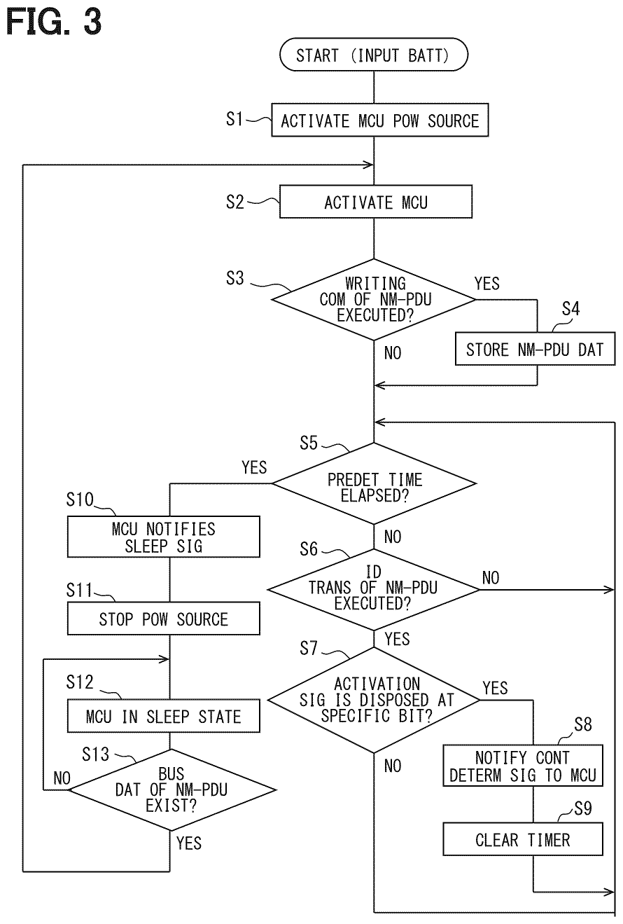

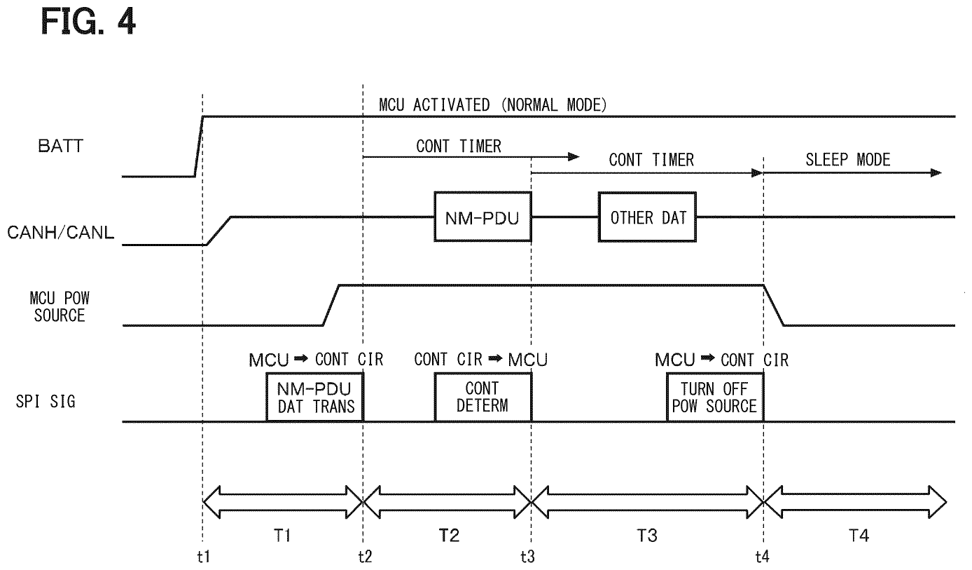

The operation when the state transitions from the normal state to the sleep state will be described with reference to the flowchart of FIG. 3 and the timing chart of FIG. 4. When the ignition switch is turned on, the electric power from the battery BA is supplied to the ECU 1, and the power source circuit 13 is activated in S1 of FIG. 3. When the power source circuit 13 is activated, the power source voltage is supplied to the MCU 20. This causes the CPU 123 of the MCU 20 to be activated and transition to the normal state (at S2 in FIG. 3 and at T1 in FIG. 4).

During the period T1 in FIG. 4, the driver IC 11 is also activated together with the MCU 20. The MCU 20 is capable of data communication with an external ECU 1 via the transceiver 111 and the communication bus 2. The CPU 123 of the MCU 20 transmits NM-PDU (i.e., Network Management PDU) data, which is an activation instruction data, to the driver IC 11 via the communication circuit 122.

When the CPU 123 of the MCU 20 enters the normal state, the CPU 123 transmits in advance to the driver IC 11 the bit information of the NM-PDU data that serves as a notification trigger for transitioning from the sleep mode to the normal state. At this time, the MCU 20 transmits the NM-PDU data via the communication circuits 112a and 122. The activation instruction data can be freely changed using a software program stored in the MCU 20.

The communication circuit 112a of the control circuit 112 determines whether or not there has been a write communication of the NM-PDU data at S3 of FIG. 3, and if it determines that there has been a write communication, the communication circuit 112a stores the NM-PDU data in the register 112b at S4 of FIG. 3. The register 112b stores the signal received from the MCU 20 via the communication circuit 112a.

This notification trigger is data corresponding to the NM-PDU data, and is a trigger signal required for transitioning to the normal state. If the communication circuit 112a of the control circuit 112 does not receive the NM-PDU data that has not been transmitted from the MCU 20, the process skips the process of S4.

In S5, the MCU 20 starts a timer and waits until a specific time has elapsed. During this time, in period T2 in FIG. 4, the transceiver 111 can receive the reception signal RX from the communication bus 2. The reception signal RX is stored in the register 112d of the control circuit 112. The reception signal RX is also transmitted to the MCU 20.

In S6, the control circuit 112 determines using the verification circuit 112c whether or not the ID of the NM-PDU data is included in the reception signal RX. At this time, even if the CPU 123 of the MCU 20 is in a normal state, the verification circuit 112c receives a signal from the communication bus 2 and acquires data corresponding to the specific communication data from the reception data.

The specific communication data here includes communication bits based on the ID of the NM-PDU signal related to network management, and an activation signal assigned to the ECU 1 of the cluster group to which the ECU 1 belongs.

If the ID of the NM-PDU signal is included in the specific communication data, the verification circuit 112c decodes whether or not a specific communication bit includes an activation signal in S7, and verifies the activation signal with the NM-PDU data stored in the register 112b. Here, the verification circuit 112c reads the payload data in the register 112d of the driver IC 11 through a decoder and determines whether a specific communication bit includes an activation signal by determining the H or L (i.e., “1” or “0”) state of the specific bit.

The verification circuit 112c determines whether the contents stored in the register 112b match the communication data of the reception signal RX of the transceiver 111, and thereby determines whether to maintain the CPU 123 of the MCU 20 in a normal state or transition the CPU 123 to a sleep state. At this time, the verification circuit 112c verifies the communication data of the reception signal RX with the data stored in the register 112b to determine whether or not to maintain the CPU 123 of the MCU 20 in the normal state.

The control circuit 112 decodes the NM-PDU data in the specific bit in S7 of FIG. 3, and if it determines that there is an activation signal and that the activation signal matches the contents of the register 112b, the control circuit 112 determines that the control circuit 112 causes the CPU 123 of the MCU 20 to continue to operate in the normal state. Then, in S8, the control circuit 112 transmits a continuation determination signal via the communication circuit 112a to prevent the CPU 123 of the MCU 20 from transitioning to the sleep state. See the operation during period T2 in FIG. 4. When the CPU 123 of the MCU 20 receives the continuation determination signal through the communication circuit 122, the CPU 123 clears the timer in S9 and repeats the process from S5. The control circuit 112 can stop the transition of the MCU 20 to the sleep state by transmitting a continuation determination signal to the MCU 20.

### Explanation of Specific Examples

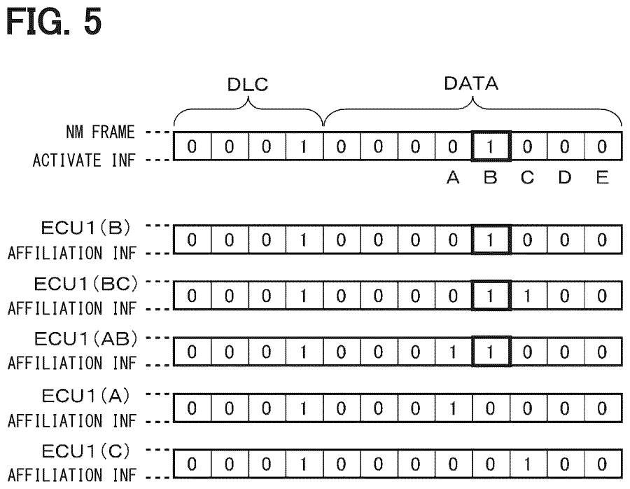

For example, as shown in FIG. 5, a case will be described in which five ECUs 1 belong to group B, group B and C, group A and B, group A, and group C, respectively. In FIG. 5, the group to which the ECU 1 belongs (for example, “(B)”, “(BC)”, and the like) is shown in parentheses.

The registers 112b of these five ECUs 1 store the information of the group to which each ECU 1 belongs (for example, an identification code indicating (A) to (E)) in the form of “H” or “L” (i.e., “1” or “0”). For example, as shown in FIG. 5, if the ECU 1 belongs to group B, the bit assigned to group B is set to “1.” If the ECU 1 belongs to group B and C, the bits assigned to group B and C are set to “1”, respectively. The same applies to other ECUs.

The verification circuit 112c refers to the DLC in the payload of the reception signal RX received from the communication bus 2 and determines that it is 1 byte. The verification circuit 112c then refers to one byte of data DATA in the payload of the reception signal RX. The verification circuit 112c of the ECU 1 assigned to group B determines that an activation signal is present by referring to “1”.

This allows the activation signal to be transmitted only to the ECU 1 that is required in the system S using the communication bus 2. Conversely, the verification circuit 112c of the ECU 1 not assigned to group B determines that there is no activation signal.

It may be preferable that the control circuit 112 transmits the continuation determination signal to the CPU 123 of the MCU 20 using the communication circuits 112a and 122. This is because the communication line between the driver IC 11 and the MCU 20 can be shared, thereby reducing the number of communication lines. Alternatively, the control circuit 112 of the driver IC 11 may use a dedicated line different from the communication lines of the communication circuits 112a and 122 when transmitting the continuation determination signal to the CPU 123 of the MCU 20. In this case, the continuation determination signal can be transmitted via a dedicated line, so the quality of the transmission signal can be guaranteed and communication reliability can be improved.

The control circuit 112 does nothing if the verification circuit 112c determines in S6 that the ID of the NM-PDU signal is not included in the reception signal RX. In this case, the process returns to S5, where the process waits until a specific time has elapsed. As shown in period T3 in FIG. 4, when the control circuit 112 does not receive an NM-PDU signal, the control circuit 112 does not transmit a continuation determination signal. This feature is also the same as when communication data other than an NM-PDU signal is received as the reception signal RX. If the ID of the NM-PDU signal is not included in the reception signal RX, and the control circuit 112 does not receive an activation signal, the verification circuit 112c does not transmit a continuation determination signal, and therefore, the transition determination to the sleep state is delegated to the CPU 123 of the MCU 20.

Even during the determination operation of the control circuit 112, the communication controller 121 of the MCU 20 reads the reception signal RX. However, on the MCU 20 side, when the ID of the NM-PDU signal arrives, the communication controller 121 reads and discards the data using the ID filtering function. On the MCU 20 side, even if an NM-PDU signal arrives as a reception signal RX, the communication controller 121 does not transmit data to the CPU 123.

Therefore, in the normal state, the arrival of an NM-PDU signal does not cause a drop in the processing capacity of the CPU 123 of the MCU 20. On the MCU 20 side, when data other than the ID related to the NM-PDU signal arrives, the communication controller 121 transmits the data to the CPU 123 side. This allows the CPU 123 to receive data of the reception signal RX other than the NM-PDU signal in the normal state. The CPU 123 executes the processing according to the received data, and can transmit a transmission signal TX to the communication bus 2 via the communication controller 121 and the transmission circuit 111a of the transceiver 111, thereby continuing normal processing.

Returning to the above explanation, if the control circuit 112 does not transmit a continuation determination signal, the MCU 20 determines that a timeout has occurred when a specific time has elapsed (“NO” in S5 of FIG. 3). When the MCU 20 determines that a timeout has occurred in S5, the MCU 20 serially transmits a sleep signal to the control circuit 112 in S10. When the control circuit 112 receives the sleep signal, the control circuit 112 disables the output of the power source circuit 13.

The power source circuit 13 of the MCU 20 stops power output in S11 of FIG. 3. As a result, the MCU 20 enters into a sleep state in S12, thereby saving power. Thus, it is possible to reduce the burden on the MCU 20 in the determination process for maintaining the normal state by itself, and also reduce the burden on the arithmetic process for executing the determination whether to transition to the sleep state. This reduces the processing load on the MCU 20.

<State Transition from Normal State to Sleep State>

When the MCU 20 is in the sleep state, and the verification circuit 112c receives specific communication data from the communication bus 2 that matches the data stored in the register 112b, the verification circuit 112c causes the MCU 20 to transition to the normal state. The control circuit 112 can cause the MCU 20 to transition from the sleep state to the normal state by transmitting a normal instruction to the MCU 20.

For example, when an NM-PDU signal indicating a communication request arrives on the communication bus 2 from another ECU 1, a reception signal RX is stored in the register 112d. The control circuit 112 detects whether an NM-PDU signal is being transmitted to the communication bus 2. The verification circuit 112c of the control circuit 112 verifies the data in the register 112d with the data in the register 112b.

The verification circuit 112c determines that an NM-PDU signal has been received by determining that the specific communication data of the NM-PDU signal matches the data stored in the register 112b. At this time, the verification circuit 112c enables the operation of the power source circuit 13, thereby causing the power source circuit 13 to output power and activate the MCU 20. This allows the control circuit 112 to cause the MCU 20 to transition from the sleep state to the normal state, and the MCU 20 can start communication.

The specific communication data includes a specific communication bit according to an ID (i.e., NM-PDU) relating to network management, and an activation signal assigned to the cluster as the group to which the device belongs. For this reason, it may be desirable that the verification circuit 112c verifies only specific communication data and specific communication bits. The verification circuit 112c can quickly determine while reducing the storage capacity of the driver IC 11 by determining only the specific communication data and the specific communication bits.

### Modifications

Here, the specific communication data that the verification circuit 112c verifies is exemplified by a specific communication bit based on an ID related to the network management (i.e., the NM-PDU signal) and an activation signal assigned to the cluster as the group to which the device belongs, but is not limited to these features.

For example, the specific communication data that the verification circuit 112c verifies may be only the activation signal assigned to the cluster as the group to which the device belongs. In this case, when the MCU 20 detects a reception signal RX in the normal state, the MCU 20 determines the ID of the NM-PDU signal relating to the network management. Therefore, the number of decoded bits to be verified by the verification circuit 112c can be reduced, and the processing load on the control circuit 112 can be reduced.

### Comparison Example

For example, if the driver IC 11 only transmits the signal, which has been transmitted to the communication bus 2, to the MCU 20 when the MCU 20 is in the normal state, and does not analyze the communication data, the MCU 20 will read all the communication data and determine whether to transition to the sleep mode. In this case, the processing load on the MCU 20 increases. Conversely, if the driver IC 11 analyzes all the reception signals RX, the processing load on the driver IC 11 will increase significantly.

### Effect of Present Embodiment

According to this embodiment, the control circuit 112 receives a signal from the communication bus 2 even when the MCU 20 is in the normal state. The control circuit 112 acquires the data corresponding to the specific communication data from the received data. The control circuit 112 compares the data with the data stored in the register 112b using the verification circuit 112c. Thus, the MCU 20 determines whether to transmit a continuation determination signal for maintaining continuous activation (corresponding to a normal state), and if the normal state is to be maintained, the MCU 20 transmits the continuation determination signal. Moreover, by not transmitting a continuation determination signal, the determination to transition to the sleep state can be delegated to the MCU 20. Specifically, the verification circuit 112c of the driver IC 11 reads the payload data and determines the “H” or “L” (i.e., “1” or “0”) of a specific bit, thereby determining whether or not to maintain the normal state with a simple configuration instead of the MCU 20.

After this, the MCU 20 can easily determine whether to transition to the sleep state by itself, and the processing load on the MCU 20 can be reduced. For example, in the above example, the MCU 20 can determine to transition to a sleep state when a specific time has elapsed and a timeout occurs.

In this embodiment, even after the MCU 20 is activated and transitions to the normal state, the driver IC 11 reads the communication data and notifies the MCU 20 if it detects an activation signal. On the other hand, when the ID related to the NM-PDU signal arrives, the communication controller 121 of the MCU 20 can read and discard the data by using the ID filtering function. Since data is no longer transmitted from the communication controller 121 to the CPU 123 of the MCU 20, the processing capacity of the CPU 123 of the MCU 20 does not decrease.

The CPU 123 of the MCU 20 can allocate its processing capacity to other tasks, enabling higher performance processing operations. Alternatively, the system S can be constructed using an MCU 20 with a relatively low processing capacity. This allows the system S to be provided at low cost.

In this embodiment, activation/shutdown of the ECU 1 (e.g., transition to a normal state or a sleep state) can be controlled for each cluster. Therefore, for example, the driver IC 11 receives a specific network management ID and specific communication data by the register 112d for only the ECU 1 that is to be activated in the sleep mode, and when the data matches the data previously received from the MCU 20 and stored in register 112b, the target MCU 20 is activated, so that it is possible to maintain the MCU 20 of the ECU 1, which does not need to be activated, to a sleep state.

### Second Embodiment

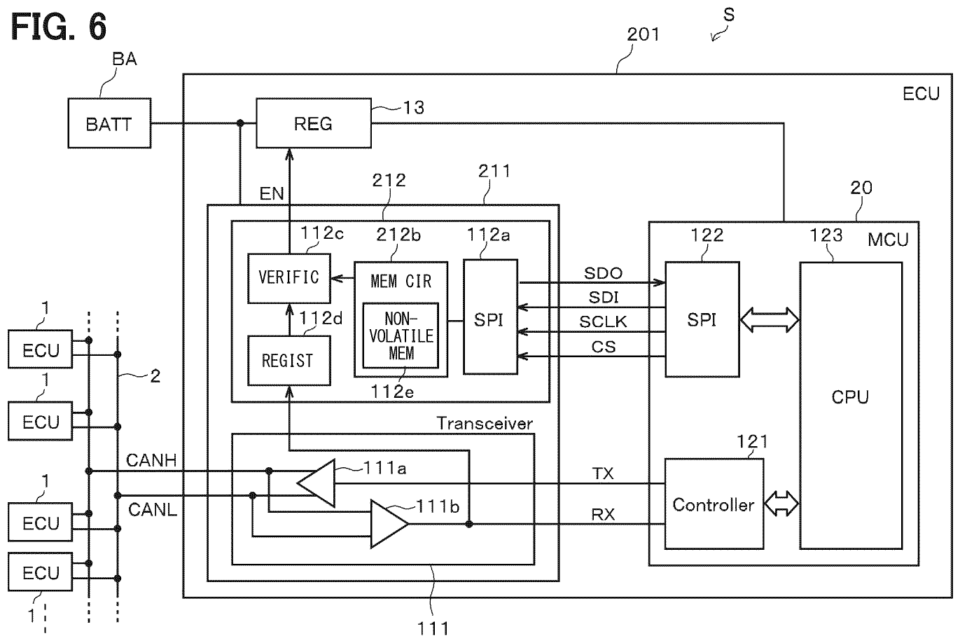

A second embodiment will be described with reference to FIG. 6.

As shown in FIG. 6, an ECU 201 instead of the ECU 1 includes a driver IC 211 instead of the driver IC 11. The driver IC 211 includes a control circuit 212. The control circuit 212 includes a memory circuit 212b instead of the register 112b. The memory circuit 212b includes a non-volatile memory 112e. In this case, it may be advisable to use a non-volatile memory 112e such as a Flash RAM. The other configuration is similar to that of the first embodiment, and hence the detailed description will be omitted.

It may be desirable that data for transitioning to the normal state is written in the non-volatile memory 112e of the memory circuit 212b by an inspection device (not shown) at the time of shipping from the manufacturing factory. In this case, the control circuit 212 can recognize the data for transitioning the MCU 20 to the normal state by referring to the data stored in the memory circuit 212b. In this case, for example, the MCU 20 does not need to write data to the memory circuit 212b through the communication circuits 122 and 112a, and it is possible to eliminate the write operation. Furthermore, the MCU 20 can also rewrite data for transitioning to the normal state to the non-volatile memory 112e of the memory circuit 212b via the communication circuit 122 and the communication circuit 112a.

### Third Embodiment

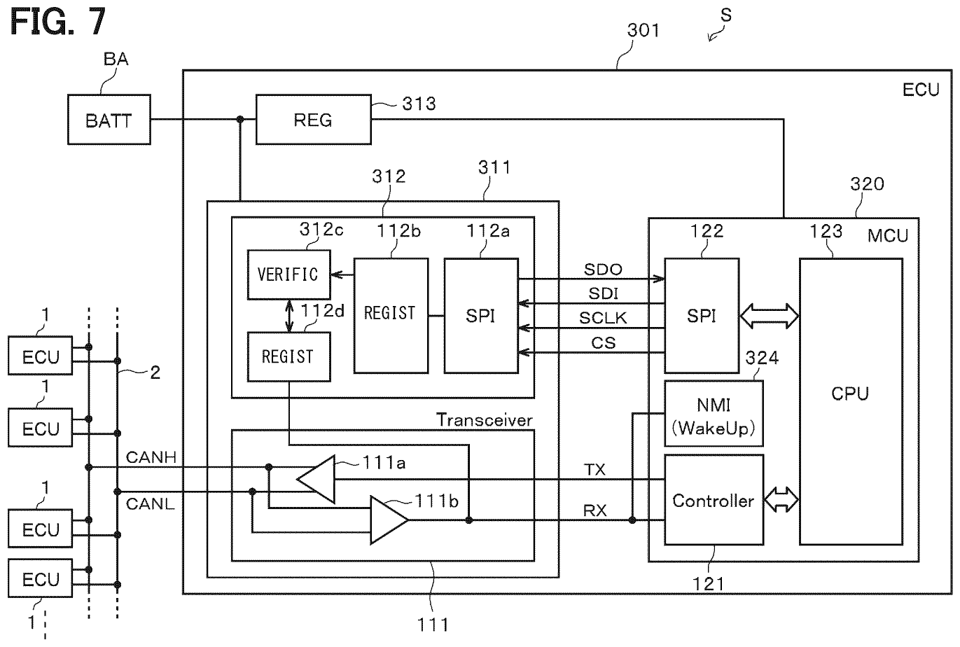

A third embodiment will be described with reference to FIG. 7.

As shown in FIG. 7, an ECU 301 instead of the ECU 1 includes an MCU 320 instead of the MCU 20, a driver IC 311 instead of the driver IC 11, and a power source circuit 313 instead of the power source circuit 13. The MCU 320 has an NMI (i.e., Non-Maskable Interrupt) input, that is, a hardware interrupt input function with incapable of masking.

The driver IC 311 includes a control circuit 312 instead of the control circuit 112. The control circuit 312 includes a verification circuit 312c, which has the same function as the verification circuit 112c. Furthermore, when the verification circuit 312c determines that the MCU 320 should be transitioned from the sleep state to the normal state, it is capable of transmitting an activation signal to the communication line for the reception signal RX via the register 112d. It should be noted that the power source circuit 313 of this embodiment does not have an enable/disable control input, and the verification circuit 312 c cannot control the output of the power source circuit 313. The power source circuit 313 is configured to supply power to the MCU 320 when the power from the battery BA is input.

In this embodiment, the control circuit 312 transmits an activation signal for transitioning the MCU 320 to the normal state through an existing communication line, which in the example of FIG. 7 is also used as the transmission line for the reception signal RX. The MCU 320 may also share the reception terminal for the activation signal with the NMI (i.e., Non-Maskable Interrupt) input of the MCU 320.

For example, when the MCU 320 transitions to the sleep state, the MCU 320 stops supplying the clock to the MCU 320. In the sleep state, the supply of the clock is stopped without stopping the output of the power source circuit 13, thereby reducing the power consumption during operation of the MCU 320 and enabling the power saving. The “clock” referred to here is the clock input to the CPU 123 of the MCU 320, and when the clock is normally supplied, for example, as illustrated in the fifth embodiment, the clock is input to the CPU 123 of the MCU 320 from the clock circuit 125, and when the clock supply is stopped, the clock is no longer input to the CPU 123.

When the control circuit 312 causes the MCU 320 to transition from the sleep state to the normal state, it may be preferable that the control circuit 312 instructs the MCU 320, which is in a state that the clock supply has stopped, to restart supplying the clock. When the MCU 320 receives an activation signal in the sleep state by the hardware interrupt function of the NMI 324, the MCU 320 starts supplying a clock to the MCU 320, forcing the MCU 320 to execute an activation operation. In this case, the power consumption of the MCU 320 can be reduced efficiently, or the MCU 320 can be quickly transitioned to the normal state.

### Modifications

The control circuit 312 may have both the function of activating the power source circuit 13 by the verification circuit 112c and the function of instructing the supply of a clock by the verification circuit 312c. Using both functions allows the control circuit 312 to wake up the MCU 320 more reliably.

### Fourth Embodiment

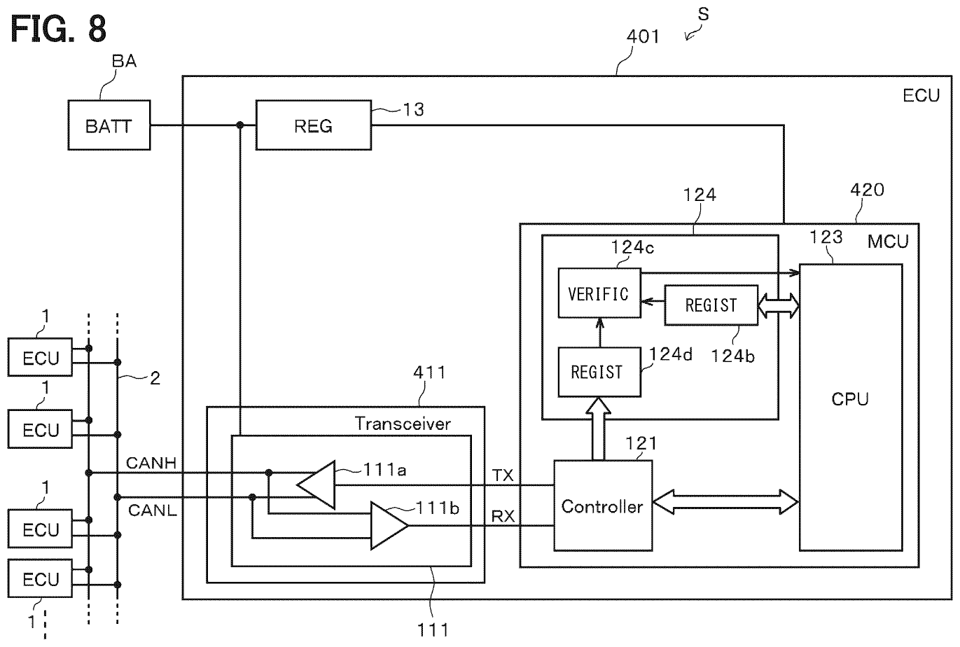

The following describes a fourth embodiment with reference to FIG. 8. As shown in FIG. 8, an ECU 401 instead of the ECU 1 includes a driver IC 411 instead of the driver IC 11 as a transceiver device. The driver IC 411 includes a transceiver 111. The transceiver 111 includes a transmission circuit 111a and a reception circuit 111b.

On the other hand, the ECU 401 includes an MCU 420 as a controller device instead of the MCU 20. The MCU 420 includes a communication controller 121, a CPU 123 as an arithmetic device, and a control circuit 124. The MCU 420 transmits and receives signals to and from a driver IC 411 connected to a communication bus 2 that connects a plurality of ECUs 1. The MCU 420 includes a communication controller 121, a CPU 123, and a control circuit 124.

The communication controller 121 transmits and receives signals through the transceiver 111. When a sleep signal is given from the CPU 123, the control circuit 124 can cause the CPU 123 to transition to a sleep mode. The CPU 123 may be configured to output a sleep signal to the control circuit 124 via the communication controller 121.

The control circuit 124 includes registers 124b and 124d as memory circuits and a verification circuit 124c, and is implemented as hardwired logic. The register 124b is used as a memory circuit for storing data for transitioning the CPU 123 of the MCU 420 from the sleep state to the normal state.

The operation when the state transitions from the normal state to the sleep state is generally the same as in the first embodiment, and will be described with reference to FIGS. 3 and 4. Here, differences from the first embodiment will be mainly described. In the normal state, the CPU 123 of the MCU 420 stores in advance in the register 124b data that serves as a notification trigger for transitioning from the sleep mode to the normal state in steps S1 to S4 of FIG. 3. The data that triggers the notification at this time corresponds to the bit information of the NM-PDU data in the first embodiment. The register 124 b of the control circuit 124 stores a signal received from the CPU 123 of the MCU 420.

The CPU 123 of the MCU 420 starts a timer in S5 of FIG. 3 and waits until a specific time has elapsed. During this time, the transceiver 111 can receive a reception signal RX from the communication bus 2. The reception signal RX is stored in the register 124d through the communication controller 121 of the MCU 420.

In S6 of FIG. 3, the control circuit 124 determines using the verification circuit 124c whether or not the ID of the NM-PDU data is included in the reception signal RX. The collation circuit 124c receives signals from the communication bus 2 even when the CPU 123 of the MCU 420 is in a normal state, and acquires data corresponding to specific communication data from the received data.

The specific communication data here includes communication bits based on the ID of the NM-PDU signal related to network management, and an activation signal assigned to the ECU 401 of the cluster group to which the ECU 401 belongs.

If the ID of the NM-PDU signal is included in the specific communication data, the verification circuit 124c decodes whether or not a specific communication bit includes an activation signal in S7 of FIG. 3, and verifies the activation signal with the NM-PDU data stored in the register 124b. Here, the verification circuit 124c reads the payload data in the register 124d through a decoder and determines whether a specific communication bit includes an activation signal by determining the H or L (i.e., “1” or “0”) state of the specific bit.

The verification circuit 124c determines whether the contents stored in the register 124b match the communication data of the reception signal RX of the transceiver 111, and thereby determines whether to maintain the CPU 123 of the MCU 420 in a normal state. At this time, the verification circuit 124c verifies the communication data of the reception signal RX with the data stored in the register 124b to determine whether or not to maintain the CPU 123 of the MCU 420 in the normal state.

The control circuit 124 decodes the NM-PDU data in the specific bit in S7 of FIG. 3, and if it determines that there is an activation signal and that the activation signal matches the contents of the register 124b, the control circuit 124 determines that the control circuit 124 causes the CPU 123 of the MCU 420 to continue to operate in the normal state. Then, the control circuit 124 directly transmits a continuation determination signal to the CPU 123 of the MCU 420 to prevent the CPU 123 from transitioning to the sleep state. The CPU 123 of the MCU 420 clears the timer in S9 of FIG. 3 and repeats the process from S5 of FIG. 3. The control circuit 112 can stop the transition of the MCU 20 to the sleep state by transmitting a continuation determination signal to the MCU 20.

The control circuit 124 does nothing if the verification circuit 112c determines in S6 of FIG. 3 that the ID of the NM-PDU signal is not included in the reception signal RX. In this case, the CPU 123 of the MCU 420 returns the process to S5 in FIG. 3 and waits until a specific time has elapsed in S5. As shown in period T3 in FIG. 4, when the control circuit 124 does not receive an NM-PDU signal, the control circuit 124 does not transmit a continuation determination signal. This feature is also the same as when communication data other than an NM-PDU signal is received as the reception signal RX. If the ID of the NM-PDU signal is not included and the activation signal is not received, the verification circuit 124c does not transmit a continuation determination signal. At this time, the CPU 123 of the MCU 420 determines whether to transition to the sleep state. The other configuration is the same as that of the preceding embodiment, and hence the description will be omitted.

### Summary of the Present Embodiment

According to this embodiment, even in the normal state, the control circuit 124 receives a signal from the communication controller 121, acquires the data corresponding to specific communication data from the received data, and verifies the data with the data stored in the register 124b using the verification circuit 124c. If the data matches, the control circuit 124 stops the transition of the CPU 123 to the sleep state by transmitting a continuation determination signal to the CPU 123 to maintain the CPU 123 in the normal state. This reduces the burden on the CPU 123 of the MPU 420 in determining whether to maintain the normal state by itself. This reduces the processing load on the CPU 123 of the MCU 420.

### Fifth Embodiment

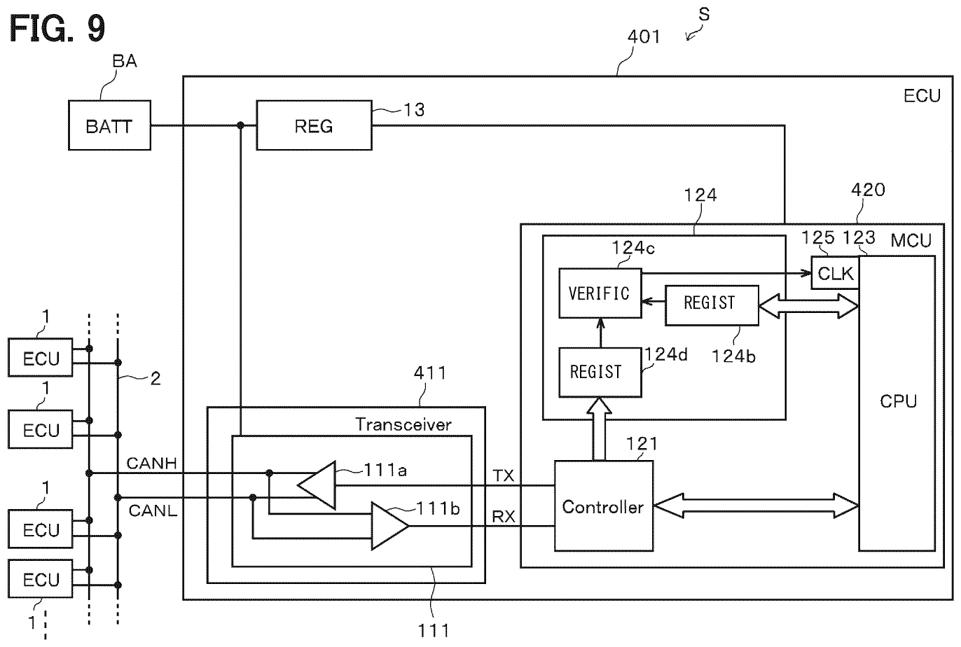

The following describes a fifth embodiment with reference to FIG. 9. The fifth embodiment differs from the fourth embodiment in that the operation of the clock circuit 125 is stopped when the CPU 123 transitions to the sleep state. The same parts as those in the fourth embodiment have the same reference numerals, and the following description focuses on the difference therebetween.

As shown in FIG. 9, a clock circuit 125 is configured inside the MCU 420, and the CPU 123 normally operates by receiving a clock from the clock circuit 125. As described in the above embodiment, the CPU 123 determines whether to transition to a sleep state when the CPU 123 does not receive a continuation determination signal from the verification circuit 124c.

When the CPU 123 itself transitions to the sleep state, the CPU 123 stores a sleep instruction signal for instructing the transition to the sleep state in the register 124b of the control circuit 124. The control circuit 124 refers to the register 124 b via the verification circuit 124c, and when it determines that a sleep instruction signal has been received from the CPU 123, the control circuit 124 stops the supply of the clock from the clock circuit 125 to the CPU 123. As a result, the CPU 123 is unable to input the clock from the clock circuit 125, so the CPU 123 stops operating and enters into a sleep state.

According to this embodiment, the control circuit 124 has a function of stopping the operation of the clock circuit 125 that supplies a clock to the CPU 123 when the control circuit 124 receives a sleep instruction signal from the CPU 123 to instruct the CPU 123 to enter a sleep state. Therefore, the CPU 123 can transition to a sleep state by issuing a sleep instruction signal.

### Other Embodiments

The present disclosure is not limited to the embodiment described above, and, for example, may be modified or expanded, which will be described.

In the fourth embodiment, the registers 124b and 124d are used, alternatively, a volatile memory such as a RAM or a non-volatile memory such as an E2PROM may be used instead.

The means and the method thereof of the present disclosure may be implemented by a dedicated computer provided by configuring a processor and a memory programmed to execute one or more functions embodied by a computer program. Alternatively, the means and the technique according to the present disclosure may be achieved by a dedicated computer provided by constituting a processor with one or more dedicated hardware logic circuits. Alternatively, the control device and method described in the present disclosure may be realized by one or more dedicated computer, which is configured as a combination of a processor and a memory, which are programmed to perform one or more functions, and a processor which is configured with one or more hardware logic circuits. The computer program may also be stored on a computer-readable and non-transitory tangible storage medium as an instruction executed by a computer.

The present embodiments include the following features in addition to the content described in claims.
Feature 1: A semiconductor integrated circuit device (11; 211; 311) receives a signal from a communication bus (2) connecting a plurality of ECUs (1).

The semiconductor integrated circuit device includes: a reception circuit (111b) that receives a signal from the communication bus, converts the signal into a voltage level of data that can be received by a controller device (20; 320) equipped with an arithmetic device (123), and causes the controller device to receive the signal as a reception signal; a transmission circuit (111a) that receives a transmission signal from the controller device, converts the transmission signal to a predetermined voltage level, and transmits the transmission signal to the communication bus; a communication circuit (112a) that is in communication with the controller device; and a control circuit (112; 212; 312) that is configured to transition the arithmetic device of the controller device from a normal state to a sleep state upon receiving a sleep signal from the controller device. The control circuit includes: a memory circuit (112b; 212b) that stores data for transitioning the arithmetic device of the controller device from the sleep state to the normal state; and a verification circuit (112c) that verifies whether specific communication data matching data stored in the memory circuit has been received from the communication bus in accordance with a predetermined communication protocol when the arithmetic device of the controller device is in the sleep state. The control circuit receives a signal from the communication bus even when the arithmetic device of the controller device is in the normal state. The control circuit acquires data corresponding to the specific communication data from received data. The control circuit verifies acquired data with the data stored in the memory circuit using the verification circuit. If the acquired data is verified, the control circuit transmits a continuation determination signal for maintaining the arithmetic device of the controller device in a normal state to the arithmetic device of the controller device, and stops transitioning the arithmetic device of the controller device to the sleep state.
Feature 2: In the semiconductor integrated device according to feature 1, the continuation determination signal is transmitted to the controller device using the communication circuit.
Feature 3: In the semiconductor integrated device according to feature 1 or 2, the communication circuit is configured to transmit data for transitioning the controller device from the sleep state to the normal state. The continuation determination signal is transmitted to the controller device using a dedicated line different from the communication line of the communication circuit.
Feature 4: In the semiconductor integrated device according to any one of features 1 to 3, the memory circuit stores data for transitioning from the sleep state to the normal state when the data is received from the controller device via the communication circuit.
Feature 5: In the semiconductor integrated device according to any one of features 1 to 4, the memory circuit includes a non-volatile memory (112e) in which data for transitioning to the normal state is written by an inspection device at a time of shipment from a manufacturing factory.
Feature 6: In the semiconductor integrated device according to any one of features 1 to 5, the predetermined communication protocol is a CAN protocol.
Feature 7: In the semiconductor integrated device according to any one of features 1 to 6, the specific communication data includes a specific communication bit according to an ID relating to network management, and an activation signal assigned to a cluster as a group to which the device belongs. The verification circuit verifies the specific communication bit and the activation signal.
Feature 8: In the semiconductor integrated device according to any one of features 1 to 7, a specific communication data is only an activation signal assigned to a cluster as a group to which the device belongs. The verification circuit verifies the activation signal.
Feature 9: In the semiconductor integrated device according to any one of features 1 to 8, the control circuit has one or both of a function for activating the controller device by activating a power source circuit of the controller device when transitioning the controller device to the normal state and a function for restarting to a clock supply to the controller device in a state where the clock supply has been stopped.
Feature 10: In the semiconductor integrated device according to any one of features 1 to 9, an activation signal for transitioning to a normal state is transmitted by sharing an existing communication line, or by sharing a reception terminal with an NMI (Non-Maskable Interrupt) input.
Feature 11: A controller device (420) transmits and receives a signal to and from a transceiver device (411) that is connected to a communication bus (2) that connects a plurality of ECUs (1). The controller device includes: a communication controller (121) that transmits and receives the signal through the transceiver device; an arithmetic device (123); and a control circuit (124) that causes the arithmetic device to transition to a sleep mode when receiving a sleep signal. The control circuit includes: a memory circuit (124b) that stores data for transitioning to a normal state; and a verification circuit (124c) that verifies whether specific communication data matching data stored in the memory circuit has been received from the transceiver device in accordance with a predetermined communication protocol when the arithmetic device is in a sleep state. The control circuit receives a signal from the communication controller even when the arithmetic device is in a normal state. The control circuit acquires data corresponding to the specific communication data from received data. The control circuit verifies acquired data with the data stored in the memory circuit using the verification circuit. If the data is verified, the control circuit transmits a continuation determination signal for maintaining the arithmetic device in the normal state to the arithmetic device, and stops transitioning the arithmetic device to the sleep state.
Feature 12: In the controller device according to feature 11, the control circuit is implemented as hardwired logic.
Feature 13: In the semiconductor integrated device according to feature 11, the controller device has a function of stopping an operation of a clock circuit (125) that supplies a clock to the arithmetic device when receiving a sleep instruction signal from the arithmetic device to instruct the arithmetic device to enter the sleep state.

In the drawings, reference numeral 1 indicates an ECU, reference numeral 2 indicates a communication bus, reference numerals 11, 211, 311, and 411 indicate driver ICs (i.e., semiconductor integrated circuit devices), reference numerals 20, 320, 420, and 520 indicate MCUs (i.e., controller devices), reference numeral 111a indicates a transmission circuit, reference numeral 111b indicates a reception circuit, reference numerals 112, 212, 312, and 124 indicate control circuits, reference numeral 112a indicates a communication circuit, reference numeral 112b indicates a register (i.e., memory circuit), reference numeral 212b indicates a memory circuit, reference numeral 112e indicates a non-volatile memory, reference numeral 122 indicates a communication circuit, and reference numeral 123 indicates a CPU (i.e., arithmetic device).

Although the present disclosure has been described in accordance with the embodiments, it is understood that the present disclosure is not limited such embodiments or structures described in the embodiments. The present disclosure includes various modifications or deformations within an equivalent range. Furthermore, various combination and formation, and other combination and formation including one, more than one or less than one element may be made within the spirit and scope of the present disclosure.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A semiconductor integrated circuit device that receives a signal from a communication bus connecting a plurality of ECUs, the semiconductor integrated circuit device comprising:
a reception circuit that receives the signal from the communication bus, converts the signal into a voltage level of data that can be received by a controller device equipped with an arithmetic device, and inputs the signal to the controller device as a reception signal;
a transmission circuit that receives a transmission signal from the controller device, converts the transmission signal to a predetermined voltage level, and transmits the transmission signal to the communication bus;
a communication circuit that is in communication with the controller device; and
a control circuit that is configured to transition the arithmetic device of the controller device from a normal state to a sleep state upon receiving a sleep signal from the controller device, wherein:
the control circuit includes:
a memory circuit that stores data for transitioning the arithmetic device of the controller device from the sleep state to the normal state; and
a verification circuit that verifies whether specific communication data matching the data stored in the memory circuit has been received from the communication bus in accordance with a predetermined communication protocol when the arithmetic device of the controller device is in the sleep state;
the control circuit receives the signal from the communication bus even when the arithmetic device of the controller device is in the normal state;
the control circuit acquires data corresponding to the specific communication data from received signal;
the control circuit verifies acquired data with the data stored in the memory circuit using the verification circuit; and
if the acquired data is verified, the control circuit transmits a continuation determination signal for maintaining the arithmetic device of the controller device in the normal state to the arithmetic device of the controller device, and stops transitioning the arithmetic device of the controller device to the sleep state.

2. The semiconductor integrated circuit device according to claim 1, wherein:
the continuation determination signal is transmitted to the controller device using the communication circuit.

3. The semiconductor integrated circuit device according to claim 1, wherein:
the communication circuit is configured to transmit data for transitioning the controller device from the sleep state to the normal state; and
the continuation determination signal is transmitted to the controller device using a dedicated line different from a communication line of the communication circuit.

4. The semiconductor integrated circuit device according to claim 1, wherein:
the memory circuit stores data for transitioning from the sleep state to the normal state when the data is received from the arithmetic device of the controller device via the communication circuit.

5. The semiconductor integrated circuit device according to claim 1, wherein:
the memory circuit includes a non-volatile memory in which data for transitioning to the normal state is written by an inspection device at a time of shipment from a manufacturing factory.

6. The semiconductor integrated circuit device according to claim 1, wherein:
the predetermined communication protocol is a CAN protocol.

7. The semiconductor integrated circuit device according to claim 1, wherein:
the specific communication data includes a specific communication bit according to an ID relating to network management, and an activation signal assigned to a cluster as a group to which each of the plurality of ECUs belongs; and
the verification circuit verifies the specific communication bit and the activation signal.

8. The semiconductor integrated circuit device according to claim 1, wherein:
a specific communication data is only an activation signal assigned to a cluster as a group to which each of the plurality of ECUs belongs; and
the verification circuit verifies the activation signal.

9. The semiconductor integrated circuit device according to claim 1, wherein:
the control circuit has one or both of a function for activating the controller device by activating a power source circuit of the controller device when transitioning the controller device to the normal state and a function for restarting to a clock supply to the controller device in a state where the clock supply has been stopped.

10. The semiconductor integrated circuit device according to claim 1, wherein:
an activation signal for transitioning to a normal state is transmitted by sharing an existing communication line, or by sharing a reception terminal with an NMI (Non-Maskable Interrupt) input.

11. A controller device that transmits and receives a signal to and from a transceiver device connected to a communication bus that connects a plurality of ECUs, the controller device comprising:
a communication controller that transmits and receives the signal through the transceiver device;
an arithmetic device; and
a control circuit that causes the arithmetic device to transition to a sleep mode when receiving a sleep signal, wherein:
the control circuit includes:
a memory circuit that stores data for transitioning to a normal state; and
a verification circuit that verifies whether specific communication data matching the data stored in the memory circuit has been received from the transceiver device in accordance with a predetermined communication protocol when the arithmetic device is in a sleep state;
the control circuit receives a signal from the communication controller even when the arithmetic device is in the normal state;
the control circuit acquires data corresponding to the specific communication data from received signal;
the control circuit verifies acquired data with the data stored in the memory circuit using the verification circuit; and
if the data is verified, the control circuit transmits a continuation determination signal for maintaining the arithmetic device in the normal state to the arithmetic device, and stops transitioning the arithmetic device to the sleep state.

12. The controller device according to claim 11, wherein:
the control circuit is implemented as hardwired logic.

13. The controller device according to claim 11, wherein:
the controller device has a function of stopping an operation of a clock circuit that supplies a clock to the arithmetic device when receiving a sleep instruction signal from the arithmetic device to instruct the arithmetic device to enter the sleep state.
